(19) United States
(12) Patent Application Publication
(10) Pub. No.: US 2013/0051539 A1
(43) Pub. Date: Feb. 28, 2013

(54) COMMUNICATIONS WITH INTERPOSED COMMERCIAL MESSAGE

(71) Applicant: Michael Sharp, Porter, TX (US)

(72) Inventor: Michael Sharp, Porter, TX (US)

(21) Appl. No.: 13/216,113

(22) Filed: Aug. 23, 2011

(51) Int. Cl. H04M 1/652; H04M 1/658

(52) U.S. Cl. 379/88.17; 379/88.22

(57) ABSTRACT

A method of operating a telephone system wherein commercial messages may be inserted into telephone calls. Telephone subscribers may be financially rewarded for participating in the system. The subscribers may switch between a mode wherein advertisements are inserted and a mode wherein advertisements are excluded from calls. The subscribers may respond to advertisements by using their telephones to connect with the advertiser. Telephone calls may be recorded at the discretion of the call participants and may be forwarded for posting on social networks. Advertisers may be given the opportunity to buy advertising time wherein their advertisements are inserted into telephone calls. Advertising time may be acquired by bidding or by fixed predetermined price purchasing.

### CROSS-REFERENCE TO RELATED APPLICATION

This application claims the benefit of the filing date under 35 USC 119(e) of the filing date of U.S. Provisional Application Ser. No. 61/236,514, filed Aug. 24, 2009, the contents of which are incorporated herein by reference.

### FIELD OF THE INVENTION

The present invention pertains to communications over communications channels, such as cellular telephone systems, and more particularly, to a system of interposing prerecorded messages into communications messages.

### BACKGROUND OF THE INVENTION

Commercial communications systems such as cellular telephone systems typically involve a connection service provided by a service provider, in exchange for fees. Typically, fees are assessed monthly, and are related to the amount of usage by the customer. As charges or fees assessed by cellular telephone service providers can be seen as costly, there exists a need for ways to reduce costs to cellular telephone service subscribers that do not reduce revenues to cellular telephone service providers.

### SUMMARY OF THE INVENTION

The present invention meets the above stated need by providing a communications service such as a telephone service at reduced cost to the user, based on acceptance by the user of commercial messages which may be introduced into telephone calls, and which are audible to the user. Just as commercial sponsors pay entertainment providers such as broadcast television services to intermix commercial messages throughout entertainment content, so may commercial sponsors introduce commercial messages into two-way personal communications such as telephone calls. Just as the revenues obtained by broadcast television services provide sufficient revenue to broadcast content without charging individual consumers to receive that content, so may a telephone service supplier be enabled to offer free or reduced cost services by having advertisers contribute to the income stream of the telephone service supplier.

The telephone service provider may maintain a server or equivalent facilities which can recognize subscribers, and which will handle calls in a way such that commercial messages may be imposed onto the two-way personal communications based on subscription to the service and identification of individual users.

A server may for example identify a user placing an outbound call, determine if the user has subscribed to the reduced cost service, and if so, interpose a commercial message which is audible to the user prior to connecting the placed call. Incoming calls may be similarly handled.

The telephone service supplier may enhance attractiveness of the telephone call, such as by maintaining a recording of the call for subsequent posting to a social networking system. The commercial message may remain part of the posted call, thereby extending the advertising value of the original message.

Charges to the advertiser may be based on the initially played message, or alternatively, could vary for example with acceptance by the user for use with social networking postings.

### BRIEF DESCRIPTION OF THE DRAWINGS

FIG. 1 is a block diagram of steps of a method of practicing the invention according to one aspect of the invention.

FIG. 2 is a block diagram of steps of a method of practicing the invention according to another aspect of the invention.

### DETAILED DESCRIPTION

The present invention combines the use of personal communications such as telephones with advertising. In one aspect of the invention, there is presented a method of managing a telephone service such that commercial messages or advertising content may be inserted at a logical place in the course of a telephone call. As employed herein, the terms “commercial message”, “advertisement”, “advertising”, and “advertising content” may generally be used interchangeably. The telephone service may be in other ways conventional telephone services wherein telephone calls are transmitted from the telephone set of one person subscribing to a telephone service to that of another person subscribing to a telephone service. As the national telephone system connects subscribers to diverse private telephone services, only one of the involved telephone services need be that which inserts advertising content into telephone conversations. Of course, it would be possible that where more than one telephone service is involved, two or more may be that which inserts advertising content into telephone conversations. It is also possible that more than two telephone services be involved. For example, a first telephone service may be that which has as a subscriber the party placing a telephone call, the second telephone service may be that which has as a subscriber the party receiving the telephone call, and a third telephone service may serve as an intermediary providing transmission facilities and services to the first and second telephone services.

The telephone system enjoying the present invention may encompass both land lines and wireless type telephones, examples of the latter being cellular telephones and other mobile communications devices. It should also be understood that the present invention may be applied to communications systems other than telephone systems, as may be appropriate. Description of the invention as applying to telephone systems is merely for semantic convenience.

Regardless of the type of communications system, the novel method of managing a telephone service may be characterized as a method of conducting telephone calls wherein a telephone call is initiated by a calling party and is directed to a receiving party. The telephone system is provided with a telephone service which transmits telephone calls and has subscribers who may use the telephone service to place and receive telephone calls. The telephone system has a management facility which is operable to recognize the subscribers to the telephone service, such as by the method applied to conventional caller identification systems. The telephone system also has a facility which can store recorded commercial messages for subsequent retrieval and insertion into ongoing telephone calls.

Using the above provided facilities, the novel method may be implemented in the following way. A telephone call being transmitted by the telephone service uses the identification feature to identify any telephone calls, either outbound, or those placed by the subscriber to another party, or inbound, or those directed to the telephone of the subscriber. As employed herein, “the telephone service” will be understood to refer to a telephone service which practices the novel method. All other telephone services, such as telephone services which play a role in initiating, receiving, or transmitting telephone calls, will be referred to as “outside telephone services”. It is of course possible for an outside telephone service to practice the invention in addition to the telephone service. However, explanation of the invention will proceed with reference to the telephone service of one particular subscriber to the telephone service and for semantic purposes in this explanation, all other telephone services will be referred to as outside telephone services even where the same telephone service has as subscribers both the party placing a call and the party receiving the placed call. That party to whom the subscriber has been connected will for semantic purposes be referred to as a remote telephone user.

Continuing with description of at least one aspect of the invention, the telephone service, when it identifies a call which is associated with a subscriber to the telephone service, whether that call is inbound or outbound, may insert a recorded commercial message or advertisement for example containing a commercial offer into the telephone call between the subscriber to the telephone service and the remote telephone user. The inserted advertisement may be inserted prior to the telephone call prior to establishing conventional audible contact between the subscriber to the telephone service and the remote telephone user.

It should be noted that because the advertisement is audible to both participants in the telephone call, it is effectively delivered to both of these parties. Either the subscriber or the remote telephone user or both may respond to the commercial offer contained within the inserted advertisement. This may be accomplished for example by depressing a key of the telephone keypad of the subscriber or of the remote telephone user. The identification system, for example, that used by caller identification services, may be utilized to assure that the transaction related to the commercial offer such that the party or parties who responded to the commercial offer will proceed in a manner involving the respondent or respondents.

In a further aspect of the invention, either the subscriber or the remote telephone user may cause the audible content of the telephone call to be recorded or saved by the telephone service by entering a command to the telephone system. Entry of a command may utilize the key of a keypad of the telephone of the subscriber or the remote telephone user. Alternatively, a spoken command may be utilized. This will result in saving or recording of the telephone call for subsequent usage. The telephone system may as part of the inserted advertisement provide an audible cue offering the option to save the audible content of the inserted advertisement.

A commercial fee or charge may be assessed for the service of saving the telephone call. For example, a charge may be entered to the telephone subscriber's telephone service account. Alternatively, a commercial fee or charge may be posted to a financial account of that party causing the audible content of the telephone cause to be saved. A financial account may be an account managed by a bank, such as a credit account or debit account.

The saved audible content may be available for subsequent usage, For example, the saved audible content may be forwarded for posting on a social network site. Twitter® and Facebook® are examples of social networks on which the audible content may be posted for availability to members of the social network. Members of the social network may have the option to retrieve and replay the posted audible content of the originally saved telephone conversation. It should be noted that the advertisement may be included with replayed audible content of the retrieved saved telephone conversation. Hence the commercial message may enjoy dissemination beyond that of the original telephone call into which it was inserted.

The method may include a feature wherein the role of inserted advertising may be practiced or discontinued from time to time at the discretion of the subscriber to the telephone service. A command such as an appropriate telephone keypad entry may temporarily discontinue the mode of telephone operation wherein commercial messages may be inserted into telephone calls of the subscriber to the telephone service, which will be referred to as the advertising mode, such that a non-advertising mode, which is essentially similar to conventional telephone system operation prevails. A second command may reestablish the advertising mode of operation. In the non-advertising mode, advertisements are inhibited from being inserted into telephone calls. This feature may be practiced where it is not desired to interrupt a particular telephone call with advertising content. By contrast, it may not be objectionable to have advertisements inserted into some telephone calls. In summary, the feature of practicing or discontinuing the advertising mode may enable the subscriber to the telephone service to switch selectively between the advertising mode and in the non-advertising mode.

The financial impetus for having advertising inserted into telephone calls is based on a system of rewarding a participating telephone service subscriber for the advertisements. There may be for example a financial reward to the subscriber to the telephone service for each advertisement inserted into his or her telephone calls. The system of financial rewards may be extended to encompass a second or additional reward for each retrieval for replay of a saved telephone conversation by a member of a social network on which the saved conversation was posted. Of course, the rewards may be determined by a bracket system, or alternatively stated, on a range of times the saved telephone call was replayed, rather on a specific count of times of replaying. Rewards may be limited to replaying saved telephone calls from social networks if desired.

Disbursement of rewards may be conducted in any desired way. For example, financial rewards of a telephone subscriber may be entered automatically into and accrue in an account and may be disbursed when the balance of accrued financial rewards exceed a predetermined threshold amount or may be disbursed based on time periods, such as monthly or quarterly. Rewards may be issued in essentially monetary form, such as checks and debit cards, may be applied to reduce an account balance (which may possibly encompass a credit balance), or in other ways and in any combination of these options.

The inventive concept may be expanded to address the issue of charges to advertisers for maintaining an inventory of commercial messages or advertisements and inserting the stored advertisements into authorized telephone calls. In reflecting this issue, the invention may be seen as a method of advertising based on inserting advertising content into telephone calls. The method would, as outlined above, include operating a telephone service wherein commercial messages may be inserted into telephone calls, establishing an inventory of commercial messages from commercial advertisers, and offering for charge to the commercial advertisers a service of inserting commercial messages into telephone conversations serviced by the telephone service. Establishing the inventory of commercial messages could if desired be limited to just a few advertisements or even just one advertisement.

The method may be practiced by recording at least one telephone conversation into a database, and posting the recorded telephone conversation to a social networking system from the database.

Charges to advertisers may be arranged in several ways. For example, charges for the service of inserting commercial messages into telephone conversations may be based on the highest one of plural bids submitted by the advertisers for the right to have a commercial message from the highest bidder be that commercial message which is inserted into each telephone call of a predefined bloc of telephone calls placed using the telephone service. A predefined bloc of telephone calls may for example comprise time limits, such as telephone calls placed within a predetermined time window or on certain dates. Alternatively, or in addition to time limits, the predetermined bloc of telephones may be defined by geographic limits, such as by neighborhood, postal code such as a ZIP code, a telephone area code, city or county borders, or the like.

Bids may be predicated on each time an advertisement is played, or may be independent of the number of times an advertisement is played.

As an alternative to bidding, fees charged to advertisers may be of the flat fee type.

The telephone service may upload preformulated advertisements from advertisers which may be preregistered sponsors. Once uploaded, an advertisement may be assigned a schedule or time window when the advertisement is a candidate for insertion into telephone calls, and a schedule regarding how many times the advertisement may be inserted into telephone calls, with or without a time window limit. Insertion of advertisements may also be correlated with predetermined blocs of telephone calls if desired.

An exemplary telephone call scenario is presented in which a subscriber or a remote telephone user places a telephone call calling the other. The call is intercepted by the telephone service and delayed, during which time an advertisement may be inserted. The party answering the ring may be connected prior to this inserted advertisement, or after the inserted advertisement. At the end of the telephone call, a synthetic voice generated by the telephone service may deliver a message or cue so that an option to save the newly completed telephone call is audibly presented. Saving may be accomplished for example by pressing a particular key on the keypad of a telephone handset. An audible acknowledgement may then be issued by the system, such as thanking the parties to the telephone call for saving the recording. A further audible message may then be issued by the telephone service, for example prompting the parties to the telephone call to press a particular key to forward the saved audible content to a Twitter® account, or another particular key to forward the saved audible content to a Facebook® account. The saved audible content may then be commercially sponsorable when retrieved by a member of the selected social network or networks.

The advertiser may for example pay a charge of five cents per insertion of the advertisement. The subscriber to the telephone service may receive a one cent reward for each time the advertisement is played during his or her telephone calls. The telephone service may then receive a profit of four cents per insertion of the advertisement.

Advertisers may be required to establish a suitable security account to assure payment of charges for insertions, such as by the PayPal® system. Payments by the advertiser and rewards to the subscriber may extend to replayings of the telephone call from social networks.

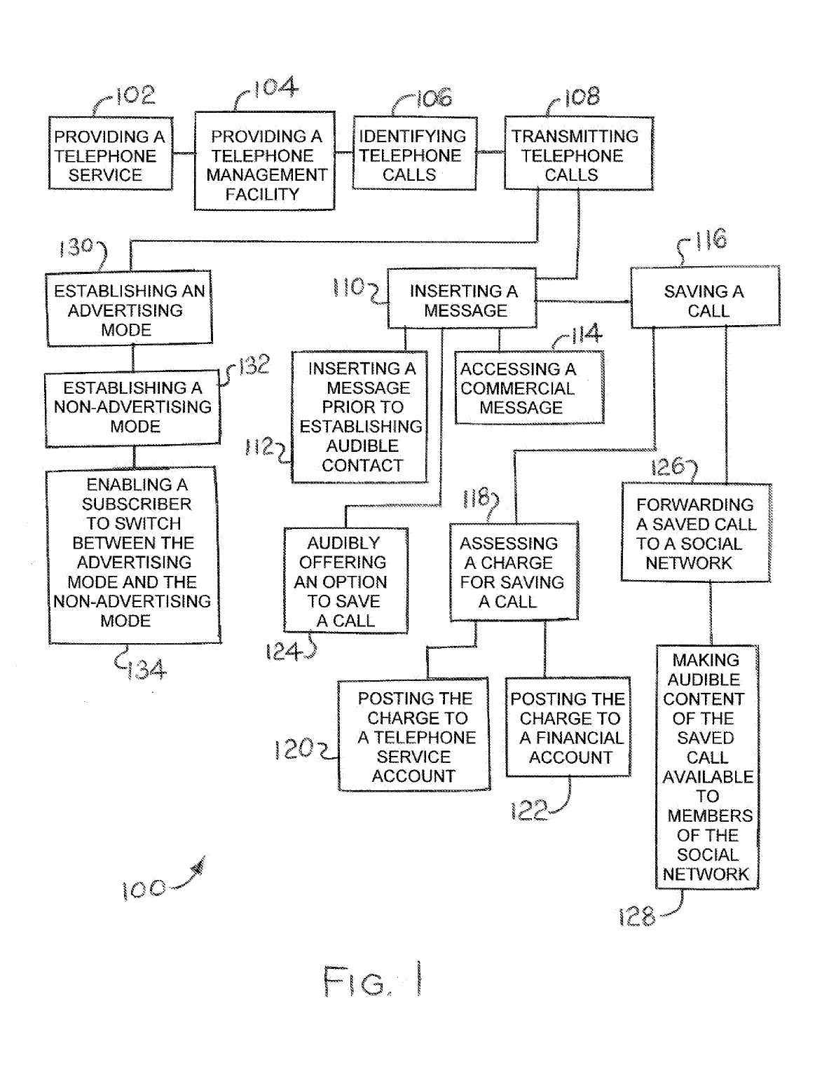

Referring now to FIG. 1, the invention may be practiced as a method 100 of conducting telephone calls wherein a telephone call is initiated by a calling party and is directed to a receiving party. The method 100 may comprise a step 102 of providing a telephone service which encompasses transmission of telephone calls using a telephone system and has subscribers which may use the telephone service to place and receive telephone calls

The method 100 may comprise a step 104 of providing a telephone management facility which is operable to recognize the subscribers to the telephone service, and to store recorded commercial messages.

The method 100 may comprise a step 106 of identifying telephone calls which are associated with a subscriber to the telephone service.

The method 100 may comprise a step 108 of transmitting a telephone call between the subscriber to the telephone service and a remote telephone user.

The method 100 may comprise a step 110 of inserting a recorded commercial message containing a commercial offer into the telephone call between the subscriber to the telephone service and the remote telephone user.

The method 100 may comprise a step 112 of making stored commercial messages audible to one of the subscriber to the telephone service and the remote telephone user prior to establishing audible contact between the subscriber to the telephone service and the remote telephone user.

The method 100 may comprise a step 114 wherein the commercial offer contained within the commercial message is accessed by at least one of the subscriber to the telephone service and the remote telephone user by depressing a telephone key of a telephone involved in the telephone call into which the commercial message has been inserted.

The method 100 may comprise a step 116 of causing the audible content of the telephone call to be saved by the telephone service responsive to a command entered by at least one of the subscriber to the telephone service and the remote telephone user.

The method 100 may comprise a step 118 of causing a commercial charge assessed for saving the audible content of the telephone call to be saved to be posted to a financial account such as a credit account or a debit account of that party causing the audible content of the telephone cause to be saved.

The method 100 may comprise a step 120 of posting the commercial charge assessed for saving the audible content of the telephone call to be saved to the telephone service account of that party causing the audible content of the telephone cause to be saved.

The method 100 may comprise a step 122 of posting the commercial charge assessed for saving the audible content of the telephone call to be saved posted to a financial transaction account of that party causing the audible content of the telephone cause to be saved.

The method 100 may comprise a step 124 wherein an audible cue offering an option to save the audible content of the telephone call is inserted into the telephone call.

The method 100 may comprise a step 126 of forwarding the audible content of a telephone call which has been saved to for posting on a social network site.

The method 100 may comprise a step 128 of making the audible content of a telephone call which has been saved and posted on a social network site retrievable by members of the social network site.

The method 100 may comprise a further step 130 of establishing an advertising mode of telephone operation wherein commercial messages may be inserted into telephone calls of a subscriber to the telephone service, a step 132 of establishing a non-advertising mode wherein commercial messages are not inserted into telephone calls of the subscriber to the telephone service, and a step 134 of enabling the subscriber to the telephone service to switch selectively between the advertising mode and in the non-advertising mode.

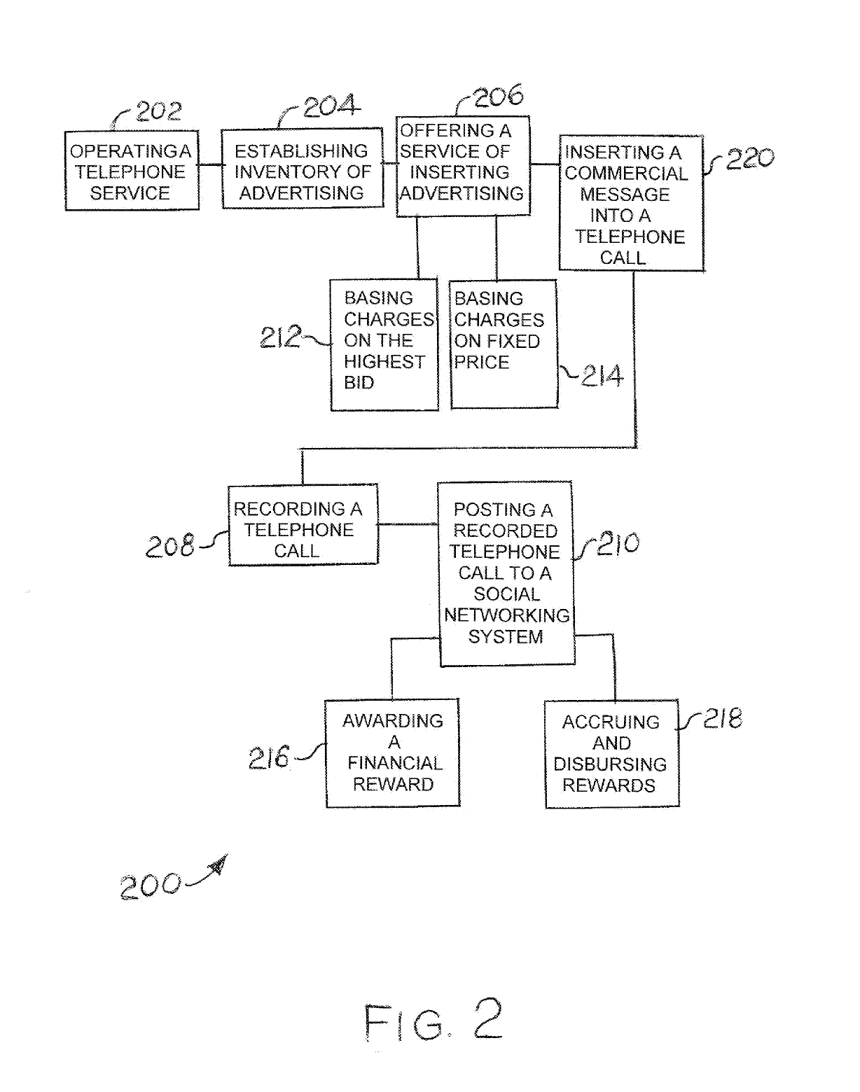

Referring to FIG. 2, the invention may be practiced as a method 200 of advertising based on inserting advertising content into telephone calls. The method 200 may comprise a step 202 of operating a telephone service wherein commercial messages may be inserted into telephone calls, a step 204 of establishing an inventory of commercial messages from commercial advertisers; a step 206 of offering for charge to the commercial advertisers a service of inserting commercial messages into telephone conversations serviced by the telephone service, a step 208 of recording at least one telephone call into a database, and a step 210 of posting the recorded telephone call to a social networking system from the database.

The method 200 may comprise a step 212 of basing charges for the service of inserting commercial messages into telephone calls on the highest one of plural bids submitted by the advertisers for the right to have a commercial message from the highest bidder be that commercial message which is inserted into each telephone call of a predefined bloc of telephone calls placed using the telephone service.

The method 200 may comprise a step 214 of basing charges for the service of inserting commercial messages into telephone calls on a fixed price charge for the right to have a commercial message from the highest bidder be that commercial message which is inserted into each telephone call of a predefined bloc of telephone calls placed using the telephone service.

The method 200 may comprise a step 216 of awarding a financial reward to a telephone subscriber to the telephone service based on the number of times a recorded telephone conversation of the telephone subscriber is accessed for replay from the social network site.

The method 200 may comprise a step 218 wherein financial rewards of a telephone subscriber accrue in an account and are disbursed when the balance of accrued financial rewards exceed a predetermined threshold.

The method 200 may comprise a step 220 of inserting a commercial message into a telephone call being transmitted by the telephone service.

The saved audible content may have a unique telephone number associated therewith so that a member of a social network could dial this number to hear the saved audible content. The advertisement may be included with the replayed audible content.

It would be possible to have commercial messages of different categories, such as of different intervals of time duration. Commercial messages may be static, in the sense of comprising an audible message which is heard by but not influenced by the participants to the telephone call into which it is inserted. Alternatively, commercial messages may be dynamic or influenced by the participants, such as being interactive. The location of insertion of an advertisement may vary, such as at the beginning of a telephone call, at the end of a telephone call, between the beginning and end of a telephone call, or any combination of these.

While the novel administrative functions have been described as being conducted by a telephone service supplier, these administrative functions could in whole or in part be conducted by a third party in cooperation with the telephone service supplier.

While the present has been described in connection with what is considered the most practical and preferred embodiments, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method of conducting telephone calls wherein a telephone call is initiated by a calling party and is directed to a receiving party, comprising the steps of:
providing a telephone service which encompasses transmission of telephone calls using a telephone system and has subscribers which may use the telephone service to place and receive telephone calls;
providing a telephone management facility which is operable to recognize the subscribers to the telephone service, and to store recorded commercial messages;
identifying telephone calls which are associated with a subscriber to the telephone service;
transmitting a telephone call between the subscriber to the telephone service and a remote telephone user; and
inserting a recorded commercial message containing a commercial offer into the telephone call between the subscriber to the telephone service and the remote telephone user.

2. The method of claim 1, comprising the further step of making stored commercial messages audible to one of the subscriber to the telephone service and the remote telephone user prior to establishing audible contact between the subscriber to the telephone service and the remote telephone user.

3. The method of claim 1, wherein the commercial offer contained within the commercial message may be accessed by at least one of the subscriber to the telephone service and the remote telephone user by depressing a telephone key of a telephone involved in the telephone call into which the commercial message has been inserted.

4. The method of claim 1, comprising the further step of causing the audible content of the telephone call to be saved by the telephone service responsive to a command entered by at least one of the subscriber to the telephone service and the remote telephone user.

5. The method of claim 4, comprising the further step of causing a commercial charge assessed for saving the audible content of the telephone call to be saved to be posted to a financial account of that party causing the audible content of the telephone cause to be saved.

6. The method of claim 4, comprising the further step of posting the commercial charge assessed for saving the audible content of the telephone call to be saved to the telephone service account of that party causing the audible content of the telephone cause to be saved.

7. The method of claim 4, wherein an audible cue offering an option to save the audible content of the telephone call is inserted into the telephone call.

8. The method of claim 4, comprising the further step of forwarding the audible content of a telephone call which has been saved to for posting on a social network site.

9. The method of claim 8, comprising the further step of making the audible content of a telephone call which has been saved and posted on a social network site retrievable by members of the social network site.

10. The method of claim 1, comprising the further steps of
establishing an advertising mode of telephone operation wherein commercial messages may be inserted into telephone calls of a subscriber to the telephone service;
establishing a non-advertising mode wherein commercial messages are not inserted into telephone calls of the subscriber to the telephone service; and
enabling the subscriber to the telephone service to switch selectively between the advertising mode and in the non-advertising mode.

11. A method of advertising based on inserting advertising content into telephone calls, comprising the steps of:
operating a telephone service wherein commercial messages may be inserted into telephone calls;
establishing an inventory of commercial messages from commercial advertisers;
offering for charge to the commercial advertisers a service of inserting commercial messages into telephone calls serviced by the telephone service;
recording at least one telephone call into a database; and
posting the recorded telephone call to a social networking system from the database.

12. The method of claim 11, comprising the further step of basing charges for the service of inserting commercial messages into telephone calls on the highest one of plural bids submitted by the advertisers for the right to have a commercial message from the highest bidder be that commercial message which is inserted into each telephone call of a predefined bloc of telephone calls placed using the telephone service.

13. The method of claim 11, comprising a further step of basing charges for the service of inserting commercial messages into telephone calls on a fixed price charge for the right to have a commercial message from the highest bidder be that commercial message which is inserted into each telephone call of a predefined bloc of telephone calls placed using the telephone service.

14. The method of claim 11, comprising the further step of awarding a financial reward to a telephone subscriber to the telephone service based on the number of times a recorded telephone call of the telephone subscriber is accessed for replay from the social network site.

15. The method of claim 14, wherein financial rewards of a telephone-subscriber accrue in an account and are disbursed when the balance of accrued financial rewards exceed a predetermined threshold.

16. The method of claim 11, comprising the further step of inserting a commercial message into a telephone call being transmitted by the telephone service.
